(19) United States
(12) Patent Application Publication
(10) Pub. No.: US 2018/0150876 A1
(43) Pub. Date: May 31, 2018

(54) PRODUCT REPLACEMENT SYSTEM

(71) Applicant: Wal-Mart Stores, Inc., Bentonville, AR (US)

(72) Inventors: David Tovey, Rogers, AR (US); Todd Mattingly, Bentonville, AR (US)

(21) Appl. No.: 15/820,511

(22) Filed: Nov. 22, 2017

Related U.S. Application Data
(60) Provisional application No. 62/427,238, filed on Nov. 29, 2016.

(51) Int. Cl. G06Q 30/02; G06Q 30/06; G06Q 20/20

(52) U.S. Cl. CPC G06Q 30/0255; G06Q 30/0633; G06Q 20/204; G06Q 30/0268; G06Q 20/202

(57) ABSTRACT

A system is described that includes a marker on a product being purchased at a point of sale. This marker provides the information on the product, but also its estimated replacement date. The information is sent to a management system which stores it in a memory storage device, the system then sends a reminder to the customer's portable computing device to remind him/her that it is time to repurchase the product. Optionally, the customer can ‘opt in’ to allow the system to automatically purchase the product when it determines that it is time to repurchase the product. In another embodiment, the product has sensors which measure wear. Product sensors are located at entrances to building and other locations which receive readings from the wear detection devices on the product. These readings indicate when it is time to replace the product. The customer is notified, and if the customer previously opted-in, the system purchases a replacement product.

### CROSS REFERENCE TO RELATED APPLICATIONS

This application claims the benefit of U.S. provisional patent application 62/427,238 filed Nov. 29, 2016, Tovey et al. entitled “Product Replacement System”, and is related to co-owned U.S. utility patent application Ser. No. 15/453,003 filed Mar. 8, 2017, High et al. entitled “Predictive Shopping”, and PCT/US17/21278 filed Mar. 8, 2017, High et al. entitled “Predictive Shopping” all of which are hereby incorporated by reference as if set forth in their entirety herein.

### FIELD

Aspects of the present invention relate to a system that automatically monitors, and reminds a customer to repurchase a product; and more specifically a system that automatically acquires approval from the customer, monitors, and repurchases a product.

### BACKGROUND

A typical consumer spends a large amount of time replacing many types of products. Consumables are products such as foods and medicines, which are used up until there is no more of the product left. Some of these products also have a time limit in which they are allowed to be used, identified by an expiration date. After this expiration date, the product should be discarded and replaced.

There are also products, such as shoes, which wear out as they are used. These do not have an expiration date, and should be replaced when they wear to a point that they are close to the maximum allowable wear. Since this depends upon how much they are used, it is difficult to determine when these should be replaced.

There have been attempts to determine when to replace items, such as U.S. Pat. No. 6,453,687 B2 issued Sep. 24, 2002 to Sharood et al., entitled “Refrigerator Monitor Unit”. This described a device which monitors the temperature of a container used to refrigerate foods. It monitors the temperature of the foods and indicates when the temperature is too high for a period of time and sets an alarm indicating that the food may spoil. Unfortunately, this only works for refrigerated goods, but does not monitor expiration dates or wear of a product.

Another attempt to address the above problem is described in U.S. Pat. No. 8,130,102 B1 issued Mar. 6, 2012 to Nguyen, entitled “Advanced Food and Drink Organization and/or Handling System”. This also describes a refrigeration device, but has an RFID (or other) product identification device. The product identification device can also read the expiration date from each product. This can then indicate which are going to expire soon. It also includes a server connected to a network that can purchase the products from the supermarket and have them delivered to the house. This system is limited to refrigerated products, cannot determine usage of a product and cannot detect the amount of wear of a product.

A European Patent EP 1 176 377 A1 published Jan. 30, 2002 owned by Whirlpool Corporation entitled “Automatic System for Generating Shopping Lists” describes another system which employs a product identification system, such as RFID or bar code which indicates the product. It may read the expiration date, or estimate one based upon the purchase date and the average life of the product. It then makes a shopping list and sends it to a store to purchase the products.

The described device, again, cannot detect when it is time to repurchase products that are replaced upon wear or amount of the product remaining.

Another device is described in US Patent Application having a publication number of US 2014/0156423 A1, published Jun. 5, 2014 that is assigned to Wal-Mart Stores, Inc. entitled “Suggesting Expired Product Replenishment Based Upon Receipt Data”. As suggested by the title, this searches receipt data to determine which products are nearing or past an expiration date. This may be effective for products which are replaced strictly by expiration date, however, it cannot accurately determine when to replace products that wear based upon usage. This also cannot detect when products are used up before their expiration date.

Currently, there is a need for a system which can automatically replace various types of products.

### BRIEF SUMMARY

According to aspects of the present inventive concepts there is provided an apparatus and method as set forth in the appended claims. Other features of the inventive concepts will be apparent from the dependent claims, and the description which follows.

At least one embodiment of the current invention provides a product replacement system 100 for automatically replacing a product purchased by a customer. The system includes a marker that is attached to the product having prestored replacement information about the product that includes a replacement date, and a point of sale (POS) device adapted to read the marker on the product and the replacement information encoded in it when purchased, and receive customer input indicating if the customer elects to receive automatic repurchase reminders for this product. The system also includes a memory storage device having a prestored electronic shopping list for a plurality of customers, and a management system coupled to the POS device adapted to receive the replacement information from the POS device of the product.

The management system is also coupled to the memory storage device, and is further adapted to update an electronic shopping list stored in the memory storage device with a reminder to replace the product prior to the replacement date, if the customer input indicates that the customer elected to receive repurchase reminders.

The management system is also coupled to a mobile computing device and is further adapted to display the reminder on the mobile computing device prior to the repurchase date.

The current invention may also be embodied as a method of automatically replacing a product 9 purchased by a customer following the steps of encoding a replacement date in a marker 110 that is attached to the product, reading the marker at a point of sale to obtain a replacement date of product, and storing a reminder to replace the product in a memory storage device.

The method then requires receiving customer input indicating if the customer elects to receive repurchase reminders regarding this product, and providing a notification message to the customer before the replacement date on a mobile computing device to replace the product if the customer input indicates that customer has elected to receive repurchase reminders.

The system may also be embodied as a product replacement system for automatically replacing a product, having a marker that is attached to the product having prestored information identifying the product, and a point of sale (POS) device 170 adapted to read the marker identifying the product when purchased, receive customer information during the purchase, and receive customer input indicating if the customer would like automatic repurchase reminders for this product.

The system also includes a wear detection device attached to the product 9 and adapted to measure wear of product, a product sensor adapted to read the measured wear from wear detection device when the product is within a predetermined distance from the product sensor, and a memory storage device having a prestored electronic shopping list for a plurality of customers. The system implements a management system that is adapted to receive the product and customer information from the POS device, receive measured wear information from the wear detection device, and estimate a replacement date of product.

The management system is also coupled to the memory storage device, and is further adapted to update an electronic shopping list stored in the memory storage device with a reminder to replace the product prior to the estimated replacement date.

The management system is also coupled to a mobile computing device and is further adapted to display the reminder on the mobile computing device prior to the estimated replacement date.

### BRIEF DESCRIPTION OF SEVERAL VIEWS OF THE DRAWINGS

The above and further advantages may be better understood by referring to the following description in conjunction with the accompanying drawings, in which like numerals indicate like structural elements and features in various figures. The drawings are not necessarily to scale; emphasis instead being placed upon illustrating the principles of the concepts. For example, the dimensions of some of the elements in the figures may be exaggerated relative to other elements to help to improve understanding of various example embodiments. Also, common but well-understood elements that are useful or necessary in a commercially feasible embodiment are often not depicted in order to facilitate a less obstructed view of these various example embodiments.

FIG. 1 is a block diagram of one embodiment of a system in accordance with the present invention.

FIG. 2 is a block diagram of another embodiment of a system in accordance with the present invention.

FIG. 3 is a simplified flowchart indicating the major steps of a process according to the embodiment of the current invention shown in FIG. 1.

FIG. 4 is a simplified flowchart indicating the major steps of a process according to the embodiment of the current invention shown in FIG. 2.

### DETAILED DESCRIPTION

At least some of the following exemplary embodiments provide an improved system and method suitable for creating and maintaining a reminder shopping list for shoppers. Many other advantages and improvements will be discussed in more detail below, or will be appreciated by the skilled person from carrying out exemplary embodiments based on the teachings herein. The exemplary embodiments have been described particularly in relation to a retail store such as a supermarket or general store for grocery and household items. However, it will be appreciated that the example embodiments may be applied in many other specific environments.

### Theory

Products that are purchased may be replaced for several different reasons. The first reason is that they have passed their expiration date recommended by the manufacturer. This would be the case with drugs. They have an expiration date that is stamped on the container, and it is recommended that any pills remaining in the container after the expiration date be disposed. This is also the case with various foods that can last, on the average, until a predetermined expiration date. It is recommended that they be replaced after the expiration date.

There are also products that are used up and should be replaced. These products need to be replaced when they are empty. For example, when the butter is gone it should be replaced. Therefore, estimating replacement date of butter is based on how much is used over time.

Then there are products like sneakers, which are replaced when they have been worn down a predetermined amount. In cases where there is no measure of how much they have worn, one may estimate a replacement date based upon an average lifetime for this item. For example, most sneakers may be replaced every three years.

In the case where one can measure the actual wear of the item, and there is information about the maximum wear of the item, one can extrapolate the rate of wear over time and estimate the date when the item should be replaced.

These methods of estimating or predicting when to replace an item will be used in the following description.

### Implementation

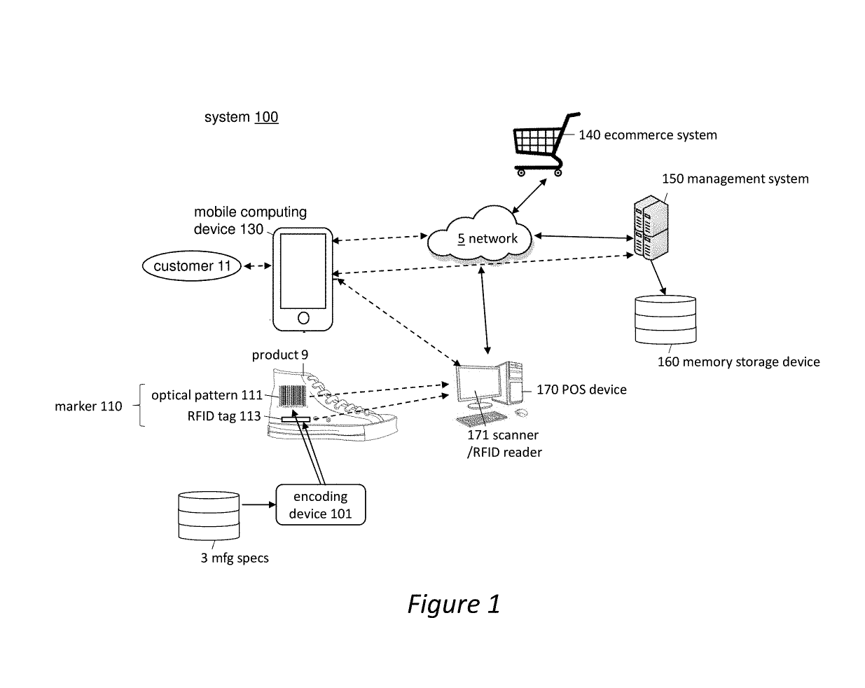

FIG. 1 is a block diagram of one embodiment of a system in accordance with the present invention.

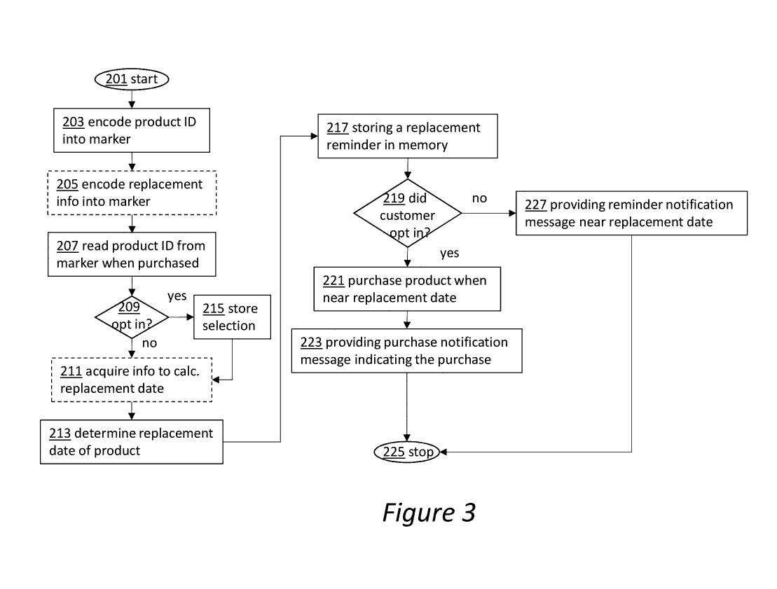

FIG. 3 is a simplified flowchart indicating the major steps of a process according to one embodiment of the present invention. This embodiment of the present invention will be explained in connection with FIGS. 1 and 3 to indicate the structure and functioning of the system according to one embodiment of the present invention.

The process starts at step 201 in FIG. 3. In step 203, a product ID which identifies the product 9 is encoded by an encoding device 101 and made part of the marker 110. Marker 110 may be an optical pattern such as a barcode, a two-dimensional barcode, a QR code or other conventional optical pattern used to encode information. Marker 110 may also be an RFID tag 113 or similar device capable of storing and transmitting information to a remote receiver.

Step 205 is an optional step. In step 205, replacement information, which may be provided by a database 3 having manufacturing specifications, is encoded through an encoding device 101 into marker 110. This replacement information may be, as indicated above, an expiration date for drugs, food, or other perishable items, a product life which indicates the typical lifetime of the product that can be added to a purchase date to result in a replacement date, or information relating to a maximum amount of wear of an item as measured by a wear sensor.

When the product 9 is purchased, typically it is scanned by a point of sale (POS) device 170. POS device 170 may include the capability to read marker 110 and the product ID encoded in marker 110. If replacement information is encoded in marker 110, it can also be read into POS device 170. POS device 170 also has the ability to keep track of the current date and time, and makes note of the date and time when product 9 is purchased. It may also keep track of other aspects of the purchase transaction such as a name and address on a credit card, credit card number, and related items purchased. At least some of this information is provided through network 5 to a management system 150 to be stored.

POS device 170 has the ability to interact with the customer 11 either directly, or through customer's mobile computing device 130. The customer is then allowed to “opt in”, or “opt out” of a service provided by the system to remind the customer when it is time to repurchase the product and if the customer opts in, to purchase the product for the customer.

In step 209 if the customer opts in (“yes”), then this information is stored in step 215 in the management system 150. If the customer does not opt in (“no”), then processing continues at step 211.

Step 211 is an optional step of acquiring information for calculation of the replacement dates, if the information was not encoded into marker 110 and read by point of sale device 170. In this optional step management system 150 may use the product ID acquired from POS device 170 and connect to and search through an online manufacturing specification database to find replacement information relating to product 9. In the case of perishable items such as drugs and food, it may be an expiration date. In the case of products which are used up over time, one may estimate the frequency of usage of that item by tapping into a database of past receipts, and determine how often a particular product is purchased. Using the same frequency or average frequency would indicate when the customer is likely to purchase the same product again. This is described in more detail in U.S. provisional patent application 62/305,790 filed Mar. 9, 2016, High et al. entitled “Predictive Shopping” which is currently pending and owned by the owner of the current application, and is hereby incorporated by reference as if set forth herein in its entirety.

In step 217 a replacement reminder is stored in memory storage device 160. Management system 150 monitors memory storage device 160 to determine when it is time to send a reminder to various customers.

A predetermined time period may be set by the customer, or set as a default that can be overridden, from the estimated replacement date. This time period may extend before, during or after the replacement date, thereby providing an advance warning, or a reminder. The customer has the ability to turn off or delay this reminder.

In step 219 if the customer opted in to allow automatic repurchasing of the product (“yes”), then in step 221 product 9 is purchased by management system 150 through network 5 through an ecommerce system 140. The product 9 is then mailed from ecommerce system 140 to customer 11.

FIGS. 1 and 3 describe the structure and functioning of the system 100 when the product 9 is not being monitored with a wear sensor.

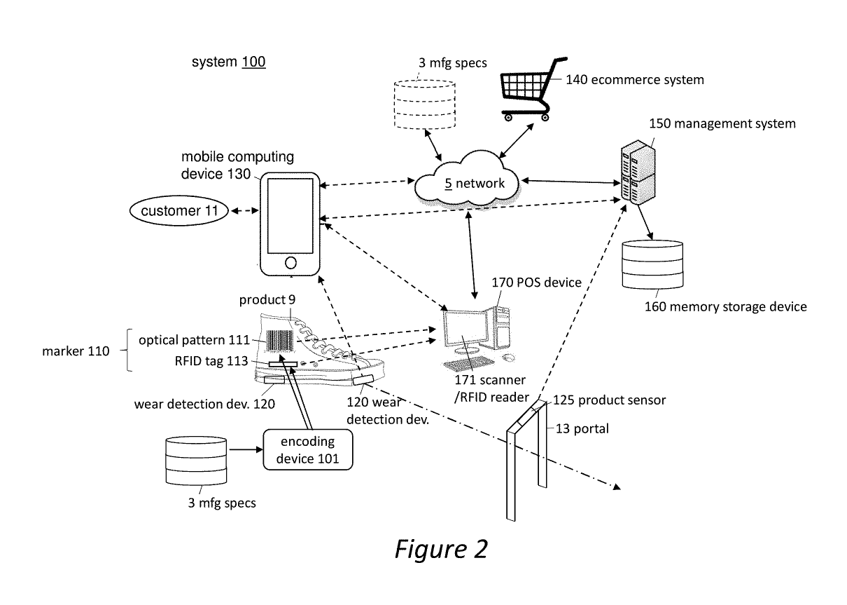

FIG. 2 is a block diagram of another embodiment of a system in accordance with the present invention.

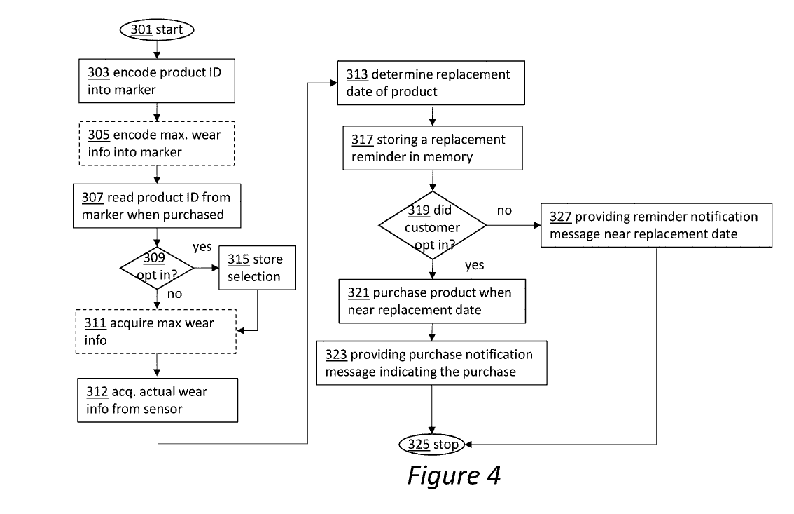

FIG. 4 is a simplified flowchart indicating the major steps of a process according to one embodiment of the present invention. This embodiment of the present invention will be explained in connection with FIGS. 2 and 4 to indicate the structure and functioning of the system according to another embodiment of the present invention.

The process starts at step 301 in FIG. 4. In step 303, a product ID which identifies the product 9 is encoded by an encoding device 101 and made part of the marker 110. Marker 110, as indicated above, may be an optical pattern such as a barcode, a two-dimensional barcode, a QR code or other conventional optical pattern used to encode information. Marker 110 may also be an RFID tag 113 or similar device capable of storing and transmitting information to a remote receiver.

Step 305 is an optional step. In step 305, a measure of wear for replacement of product 9 is acquired from a manufacturing database 3 encoded through an encoding device 101 and marker 110. This wear information may be provided by a wear detection device 120 embedded in the product 9 that indicates the amount of wear. When the amount of wear is within a predetermined amount of a maximum allowable wear, the system recommends that the product 9 be replaced.

When the product 9 is purchased, it is typically scanned by a point of sale (POS) device 170. POS device 170 will have the ability to read marker 110 and the product ID encoded in marker 110. If replacement information is encoded in marker 110, it can also be read into POS device 170. POS device 170 also has the ability to keep track of the current date and time, and makes note of the date and time that product 9 is purchased. POS device 170 also keeps track of other aspects of the purchase transaction such as a name and address on a credit card, credit card number, and related items purchased. At least some of this information is provided through network 5 to a management system 150 to be stored.

POS device 170 has the ability to interact with the customer 11 either directly, or through customer's mobile computing device 130. The customer is then allowed to “opt in”, or “opt out” of a service provided by the system to remind the customer 11 when it is time to repurchase the product and if the customer opts in, to purchase the product for the customer.

In step 309 if the customer opts in (“yes”), then this information is stored in step 315 in the management system 150. If the customer does not opt in (“no”), then processing continues at step 311.

Step 311 is an optional step to acquire information for calculation of the replacement dates, if this information was not encoded into marker 110, as described above. In this optional step, management system 150 may use the product ID acquired from POS device 170 and connect to, search through and obtain wear information indicating when it is time to replace product 9 from an online manufacturing specification database 3.

Optionally, for products 9 which wear over time, this information can also be an estimated period of use under normal wear conditions. Adding this estimated period to the purchase date of product 9 results in a replacement date. This calculation of the replacement date may be used as a default date in the event that the wear detection device 120 malfunctions. In another optional embodiment, this calculation of the replacement date can be used as another trigger for replacement of the product 9. For example, if the estimated replacement date is before the replacement date calculated from readings from the wear detection device 120, then a reminder is provided based upon this earlier date. If overridden, then the reminder will be triggered by the replacement date calculated by the wear detection device 120.

The system should also be able to measure a percentage of wear and percent relative to the usable life of the product. This is useful since end of usable life, or the replacement date provided by manufacturers is an estimate of when the products typically should be replaced. In certain cases, when a product is used extensively or is subject to extreme environments, the products deteriorate quickly and may need to be replaced earlier. Therefore, the current invention employs sensors to measure wear.

Wear measurement is useful for numerous categories of products. For example, it would be helpful to know the current state of batteries or battery powered devices relative to their useful life.

It would also be useful to measure the state of wear of air and water filters compared to their usable life. As they are used, they lose efficiency, begin to clog, etc.

Another example would be to employ sensors on flea collars on pets to determine how much usable life is left on them. This may be based upon current measurement compared to the minimum usable measurement. This would allow a pet owner to replace the flea collar before the collar is ineffective, and allows the pet to accumulate fleas and bring them into the owner's house. This may happen even though it is before the end-of-life date indicated by the manufacturer.

It can also be useful in the case of paints, varnishes and similar substances used to protect structures, since various parts of a structure, such as a house, receive varying amounts of sunlight, rain, snow, etc. It is understandable that different parts of the same house, painted at the same time, would require repainting before others. Since the house is stationary, if it has sensors mounted at various locations, the sensor reader would have to be mobile. One example would be for a user to carry a sensor reader that would read the amount of wear sensed by various sensors. This would allow a user to walk around a house having wear sensors and get a quick and accurate reading of which parts of the house need to be repainted. Using this system would allow repainting before there is any underlying damage to the wood or other materials protected by the paint.

In other embodiments, the reminder and purchase may be triggered from either or both of these replacement dates.

In step 317 a replacement reminder is stored in memory storage device 160. Management system 150 monitors memory storage device 160 to determine when it is time to send a reminder to various customers.

As with the previous embodiment, a predetermined time period may be set by the customer, or set as a default that can be overridden, from the estimated replacement date. This time period may extend before, during or after the replacement date, thereby providing an advance warning, or a reminder. The customer has the ability to turn off, or delay this reminder.

In step 319 if the customer opted in to allow automatic repurchasing of the product (“yes”), then in step 321 product 9 is purchased by management system 150 through network 5 through an ecommerce system 140. The product 9 is then mailed from ecommerce system 140 to customer 11.

Although a few examples have been shown and described, it will be appreciated by those skilled in the art that various changes and modifications might be made without departing from the scope of the invention, as defined in the appended claims.

What is claimed is:

1. A product replacement system for automatically replacing a product purchased by a customer, comprising:
a marker that is attached to the product having prestored replacement information about the product indicating a replacement date;
a point of sale (POS) device adapted to
read the marker on the product and the replacement information encoded in it when purchased, and
receive customer input indicating if the customer elects to receive automatic repurchase reminders for this product;
a memory storage device having a prestored electronic shopping list for a plurality of customers;
a wear detection device attached to product, coupled to the mobile computing device functioning to estimate when the product has degraded past a predetermined point, and provide a signal to the mobile computing device that the product should be replaced;
a management system is coupled to the POS device adapted to receive the replacement information from the POS device of the product;
wherein the management system is also coupled to the memory storage device, and is further adapted to update an electronic shopping list stored in the memory storage device with a reminder to replace the product prior to the replacement date, if the customer input indicates that the customer elected to receive repurchase reminders;
wherein the management system is also coupled to a mobile computing device and is further adapted to display the reminder on the mobile computing device prior to the repurchase date.

2. The product replacement system of claim 1, further comprising:
an encoder adapted to receive replacement information about the product indicating a replacement date, and encode it into a marker that is attached to the product.

3. The product replacement system of claim 1, wherein the replacement information includes an expiration date of the product that is used in place of the replacement date.

4. The product replacement system of claim 1, wherein the marker is at least one of:
an RFID tag, a barcode, a QR code, an optical pattern.

5. The product replacement system of claim 1, wherein the management system is further adapted to:
connect to a manufacturer's specifications device through a network;
search for information on the product to find a replacement date and send the replacement date to the management system to store as the replacement date in the memory storage device.

6. The product replacement system of claim 1 wherein the product comprises:
a wear detection device adapted to monitor product degradation and provide a signal indicating a degree of degradation to the mobile computing device; and
the mobile computing device monitors the degradation and estimates a replacement date of the product; and
the mobile computing device sends the estimated replacement date to the management system to update the replacement date in the memory storage device.

7. The product replacement system of claim 1 wherein the management system has previously received authorization for automatic purchasing, is further adapted to:
connect to an ecommerce system; and
purchase the product a predetermined period of time from the replacement date.

8. The product replacement system of claim 7 wherein the predetermined period of time from the replacement date is determined by input to the mobile computing device.

9. The product replacement system of claim 7 wherein the mobile computing device
calculates a percentage of wear based upon the degree of degradation; and
displays the percentage of wear on the mobile computing device.

10. A method of automatically replacing a product purchased by a customer comprising the steps of:
encoding a product ID into a marker that is attached to the product;
reading the marker with a point of sale (POS) device to obtain a product ID to identify the product, and associating it with a date that the product was purchased;
obtaining an estimated replacement date of product;
storing a reminder to replace the product in a memory storage device;
receiving customer input at the POS device indicating if the customer elects to receive repurchase reminders regarding this product, and
providing a notification message to the customer a predetermined time period from the replacement date on a mobile computing device to replace the product if the customer input indicates that customer has elected to receive repurchase reminders.

11. The method of claim 10 further comprising the steps of:
acquiring customer input indicating approval to automatically purchase the product;
automatically purchasing the product through an on-line ecommerce system within a predetermined time period of the repurchase date, if the customer input indicates approval to automatically purchase the product.

12. The method of claim 10 wherein the step of reading the marker comprises the step of:
reading the marker during purchase of the product at a POS device.

13. The method of claim 10 wherein the step of reading the marker comprises the step of:
reading the marker when the product passes by a product sensor.

14. The method of claim 10 wherein the marker is at least one of:
an RFID tag, a barcode, a QR code, and an optical pattern.

15. A product replacement system for automatically replacing a product, comprising:
a marker that is attached to the product having prestored information identifying the product;
a point of sale (POS) device adapted to:
read the marker identifying the product when purchased, and
receive customer information during the purchase;
receive customer input indicating if the customer would like automatic repurchase reminders for this product;
a wear detection device attached to the product and adapted to measure wear of product;
a product sensor adapted to read the measured wear from wear detection device when the product is within a predetermined distance from the product sensor;
a memory storage device having a prestored electronic shopping list for a plurality of customers;
a management system adapted to:
receive the product and customer information from the POS device,
receive measured wear information from the wear detection device,
estimate a replacement date of product;
wherein the management system is also coupled to the memory storage device, and is further adapted to update an electronic shopping list stored in the memory storage device with a reminder to replace the product prior to the estimated replacement date;
wherein the management system is also coupled to a mobile computing device and is further adapted to display the reminder on the mobile computing device prior to the estimated replacement date.

16. The product replacement system of claim 15, wherein the marker is at least one of:
an RFID tag, a barcode, a QR code, an optical pattern.

17. The product replacement system of claim 15 wherein the management system receives user input electing automatic purchasing, and the management system is further adapted to:
connect to an ecommerce system; and
send a purchase order for the product to the ecommerce system a predetermined period of time from the replacement date.

18. The product replacement system of claim 17 wherein the predetermined period of time from the replacement date is determined by user input.

19. The product replacement system of claim 15, wherein product is a product that physically degrades after repeated usage.

20. The product replacement system of claim 15, wherein product is a product that has replaceable parts that wear, and the replacement date relates to these replaceable parts.

21. The product replacement system of claim 15, wherein the management system calculates a percentage of wear and displays this information on the mobile computing device.
